(19) United States
(12) Patent Application Publication
(10) Pub. No.: US 2013/0266357 A1
(43) Pub. Date: Oct. 10, 2013

(54) RECORDING MEDIUM EJECTION DEVICE AND IMAGE FORMING APPARATUS

(71) Applicant: KYOCERA DOCUMENT SOLUTIONS INC., Osaka (JP)

(72) Inventors: Keisuke EGAWA, Osaka (JP); Terumitsu NOSO, Osaka (JP); Shota ONISHI, Osaka (JP)

(73) Assignee: KYOCERA DOCUMENT SOLUTIONS INC., Osaka (JP)

(21) Appl. No.: 13/857,839

(22) Filed: Apr. 5, 2013

(30) Foreign Application Priority Data
Apr. 6, 2012 (JP) 2012-087301

(51) Int. Cl. G03G 15/00

(52) U.S. Cl. CPC G03G 15/6552
USPC 399/405

(57) ABSTRACT

A job separator includes a conveyance port communicating with a paper conveyance path in a main body of an image forming apparatus, an exit port open toward a second exit tray, and a reversing port configured to switch back paper in forming images on both surfaces of the paper. A branch guide, which is configured to switch a paper conveyance direction between toward the exit port and toward the reversing port, is arranged upstream of the exit port and the reversing port in a paper ejection direction.

### INCORPORATION BY REFERENCE

The present application claims priority under 35 U.S.C. §119 to Japanese Patent Application No. 2012-087301, filed Apr. 6, 2012. The contents of this application are incorporated herein by reference in their entirety.

### BACKGROUND

The present disclosure relates to a recording medium ejection device that ejects a sheet-like recording medium and an image forming apparatus including it (e.g., a copier, a printer, a facsimile machine, etc.).

In general, electrographic image forming apparatuses perform a series of processes in which after an electrostatic latent image formed on an image carrier, such as a photosensitive drum, is visualized as a toner image with developer, the toner image is transferred onto paper (a recording medium) and then receives heat and pressure in a fixing section to be fixed on the paper.

In order to form images on both surfaces of the paper in an image forming apparatus, an image is formed on one of the surfaces of the paper, and then an image is formed uninterruptedly on the reverse surface of the paper. In forming images on both surfaces of the paper as above, after an image is formed on one of the surfaces of paper, the paper is switched back, is reversed, and then is returned to an image forming section.

Conventionally, an ejection roller pair arranged at a paper exit port switches back the paper. At this time, the tip end of the paper subjected to switch back may twitch the upper surface of paper already stocked (stacked) on a paper exit tray to move the stocked paper toward the paper exit port. In this case, the stocked paper may be misaligned. Or, the paper moved toward the paper exit port may be caught together with the switched-back paper by the ejection roller pair.

In view of the foregoing, in order to achieve better alignment and stackability of the paper, it has been examined to press the stocked paper by a paper pressing member extending from the upper part of the paper exit port substantially perpendicularly downward relative to a direction in which the paper is discharged. For example, an image forming apparatus is provided in which a mylar as a pressing means is mounted within an optimum range to effectively press the right and left end parts of the paper, which are parts liable to be curled.

Further, an image forming apparatus is examined in which a sheet pressing member is arranged coaxially with a full load detection member. In this image forming apparatus, only the full load detecting member presses narrow paper, while both a sheet pressing member and the full load detection member press wide paper, thereby pressing paper by appropriate pressing force corresponding to the width of the paper.

### SUMMARY

A recording medium ejection device according to the present disclosure includes: an exit port from which a recording medium is ejected; an ejection roller pair arranged at the exit port; a reversing port formed above the exit port; and a branch guide provided in a conveyance path through which the recording medium is conveyed to the exit port. The branch guide is configured to move between a first position to guide the recording medium to the exit port and a second position to guide the recording medium to the reversing port. With the branch guide located at the first position, the ejection roller pair is rotated to eject the recording medium from the exit port. With the branch guide located at the second position, a conveyance roller pair, which is located upstream of the ejection roller pair in a recording medium ejection direction, is rotated to allow part of the recording medium to be projected from the reversing port and is rotated in a reverse direction to switch back the recording medium.

An image forming apparatus according to the present disclosure is an image forming apparatus in which an inner ejection space is formed so as to open at least at the front of the image forming apparatus. The image forming apparatus according to the present disclosure includes: a recording medium ejection device; an image forming section arranged upstream of the recording medium ejection device in a recording medium ejection direction and configured to form an image on a recording medium; a first exit tray formed on the bottom of the inner ejection space; a first main body side ejection roller pair configured to eject the recording medium onto the first exit tray; a second main body side ejection roller pair arranged above the first main body side ejection roller pair upstream of the recording medium ejection device; and a second exit tray detachably provided downstream of the recording medium ejection device. The recording medium ejection device includes: an exit port from which a recording medium is ejected; an ejection roller pair arranged at the exit port; a reversing port formed above the exit port; and a branch guide provided in a conveyance path through which the recording medium is conveyed to the exit port. The branch guide is configured to move between a first position to guide the recording medium to the exit port and a second position to guide the recording medium to the reversing port. With the branch guide located at the first position, the ejection roller pair is rotated to eject the recording medium from the exit port. With the branch guide located at the second position, the second main body side ejection roller pair, which is located upstream of the ejection roller pair in the recording medium ejection direction, is rotated to allow part of the recording medium to be projected from the reversing port and is rotated in a reverse direction to switch back the recording medium.

### BRIEF DESCRIPTION OF THE DRAWINGS

FIG. 1 is a schematic cross sectional view showing an internal configuration of an image forming apparatus 100 according to one embodiment of the present disclosure.

FIG. 2 is a perspective view of an outer appearance of a job separator 25 boarded on the image forming apparatus 100 in FIG. 1.

FIG. 3 is a side cross sectional view showing an internal configuration of the job separator 25.

FIG. 4 is a partial perspective view showing the vicinity of a supporting point 37a of a branch guide in ejecting paper from an exit port 33 of the job separator 25.

FIG. 5 is a side view of the job separator 25 in the state shown in FIG. 4 as viewed from the rear side of the paper of FIG. 2.

FIG. 6 is a side cross sectional view of the job separator 25 in the state shown in FIG. 4.

FIG. 7 is a partial perspective view showing the vicinity of the supporting point 37a of the branch guide 37 in paper switch back using a reversing port 35.

FIG. 8 is a side view of the job separator 25 in the state shown in FIG. 7 as viewed from the rear side of the paper of FIG. 2.

FIG. 9 is a side cross sectional view of the job separator 25 in the state shown in FIG. 7.

FIG. 10 is a partially enlarged view of the vicinity of the exit port 33 of the job separator 25 in FIG. 3.

FIG. 11 is a schematic cross sectional view showing another example of the configuration of the image forming apparatus 100 according to the present disclosure.

### DETAILED DESCRIPTION

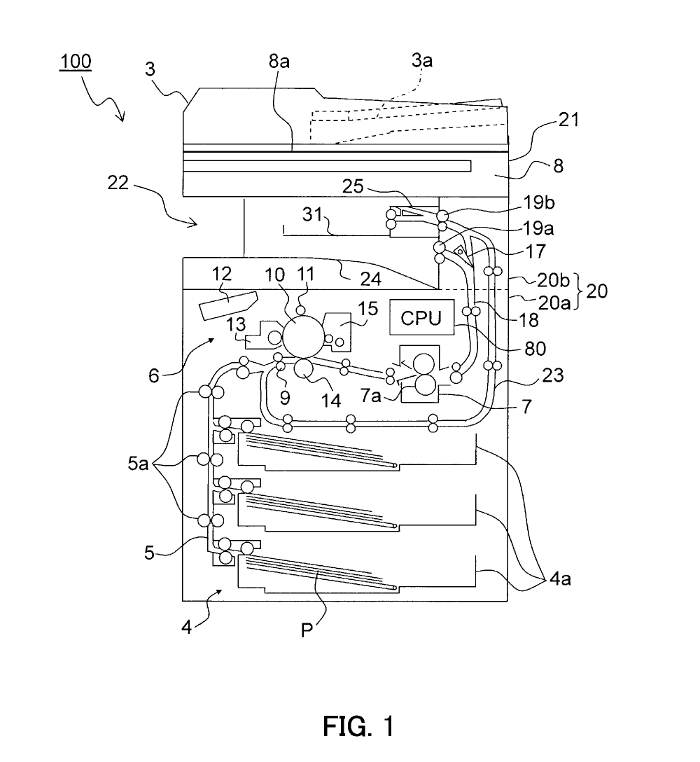

Embodiments of the present disclosure will be described below in detail with reference to the accompanying drawings. FIG. 1 is a schematic diagram showing an internal configuration of an image forming apparatus 100 according to one embodiment of the present disclosure. As shown in FIG. 1, the image forming apparatus 100 is generally called a digital multifunction peripheral of inner output type. The image forming apparatus 100 includes a main body housing 20 and an upper housing 21 arranged above the main body housing 20. The upper housing 21 includes various types of mechanisms, which will be described later, to read an image of an original document as an electric signal. A document feeder 3 is provided on the upper housing 21. By contrast, the main body housing 20 includes various types of mechanisms, which will be described later, to transfer the image to a recording medium on the basis of the electric signal of the read image of the original document. Further, inside the image forming apparatus 100, there are provided a control section (CPU) 80 to control operations of various devices and members for the image forming apparatus 100. It is noted that one example of the recording medium is referred to as paper P.

The main body housing 20 is composed of a lower housing 20a and a joint housing 20b in the present embodiment. The joint housing 20b extends upward on the right side in FIG. 1 from the lower housing 20a and is connected to the upper housing 21. A paper feed section 4, an image forming section 6, a fixing section 7, etc. are provided in the lower housing 20a. The paper feed section 4 feeds paper P. The image forming section 6 forms a toner image on the paper P. The fixing section 7 fixes the toner image formed on the paper P. By contrast, a paper ejection section is provided in the joint housing 20b. The paper ejection section is configured to convey the paper P to which the toner image is fixed and to eject it out from the main body housing 20. Further, an inner ejection space 22 is formed on the left side of the joint housing 20b below the upper housing 21. The inner ejection space 22 opens at least at the front of the image forming apparatus 100. In the present embodiment, the inner ejection space 22 opens wide at the left side and the front of the image forming apparatus 100.

Inside the main body housing 20, there are arranged the paper feed section 4, a paper conveyance section 5, the image forming section 6, and the fixing section 7. The paper feed section 4 is arranged in the lower part of the main body housing 20. The paper conveyance section 5 is arranged from one side of the paper feed section 4 to thereabove. The image forming section 6 is arranged above the paper feed section 4. The fixing section 7 is arranged downstream of the image forming section 6 in a direction in which the paper is conveyed (a paper conveyance direction; right in FIG. 1). The image forming section 6 and the fixing section 7 are arranged so that the longitudinal direction of the image forming section 6 and the fixing section 7 is parallel to a width direction (a direction perpendicular to the paper of FIG. 1) orthogonal to the paper conveyance direction inside the image forming apparatus 100.

The paper feed section 4 includes a plurality of paper feed cassettes 4a. Each paper feed cassette 4a includes a separate feed means, such as a paper feed roller, etc., on the downstream side in the paper conveyance direction. By rotation of the paper feed roller, a sheaf of the paper P, which is placed on each paper feed cassette 4a, is fed sheet by sheet from the uppermost paper P to the paper conveyance section 5. The paper conveyance section 5 conveys using a corresponding conveyance roller pair 5a the paper P fed from the paper feed section 4 to the image forming section 6.

The image forming section 6 is configured to form a given toner image on the paper P by an electrophotographic process. The image forming section 6 includes a photosensitive drum 10, an electrostatic charger 11, an exposure device 12, a developing device 13, a transfer device 14, a cleaning device 15, and a charge neutralizing device (not shown). The photosensitive drum 10 is an image carrier rotatably supported to a rotary shaft. The electrostatic charger 11, the exposure device 12, the developing device 13, the transfer device 14, the cleaning device 15, and the charge neutralizing device are arranged around the photosensitive drum 10 in the direction of rotation of the photosensitive drum 10. The fixing section 7 is configured to fix a non-fixed toner image formed on the paper P in the image forming section 6 onto the paper P. Specifically, the fixing section 7 allows the paper P to be held between a fixing roller pair 7a of a heating roller and a pressure roller and heats and presses the paper P, thereby fixing the non-fixed toner image to the paper P.

An image reading section 8 is provided inside the upper housing 21. The image reading section 8 is configured to read image information of an original document. In order to read the image information of an original document placed page by page manually, the document feeder 3 is opened, and the original document is placed on a contract glass 8a provided on top of the upper housing 21. Further, in order to automatically read the image formation of a sheaf of original documents sheet by sheet, the sheaf of original documents is placed on a paper feed tray 3a of the document feeder 3 in a closed state. When the sheaf of original documents is placed on the paper feed tray 3a, the original documents in the sheaf are automatically and successively forwarded onto the contact glass 8a sheet by sheet. In either case, an exposure lamp (not shown) irradiates light to each original document placed on the contact glass 8a. Light reflected by the original document is led as image light to a photoelectric conversion section (a CCD) via a reflection mirror, imaging lens, etc. (not shown).

Basic operation of the image forming apparatus 100 with the above configuration shown in FIG. 1 will be described below. First, the electrostatic charger 11 electrostatically charges uniformly the surface of the photosensitive drum 10 that is rotating in the anticlockwise direction. Subsequently, the exposure device 12 (a laser scan unit or the like) irradiates a laser beam to the peripheral surface of the photosensitive drum 10 on the basis of the image information read in the image reading section 8. This forms an electrostatic latent image on the surface of the photosensitive drum 10. The developing device 13 supplies toner as a developer to the electrostatic latent image to form a toner image.

In parallel to formation of the toner image, the paper P is sent out from the paper feed section 4 to a paper conveyance path 5 and stops once at the registration roller pair 9. Then, the paper once stopped at the registration roller pair 9 is conveyed at predetermined timing toward the photosensitive drum 10 on which the toner image is formed. Then, the transfer device 14 composed of a transfer roller and the like transfers the toner image on the photosensitive drum 10 to the paper P. Thereafter, the paper P to which the toner image is transferred is separated from the photosensitive drum 10 and is conveyed toward the fixing section 7. When the paper P to which the toner image is transferred passes through the fixing roller pair 7a, heat and pressure are applied to the paper P to fix the toner image to the paper P.

After completion of transfer of the toner image to the paper P by the photosensitive drum 10, the cleaning device 15 removes residual toner remaining on the peripheral surface of the photosensitive drum 10. Further, the charge neutralizing device (not shown) removes residual charge of the photosensitive drum 10. Thereafter, the electrostatic charger 11 electrostatically charges again the peripheral surface of the photosensitive drum 10. Then, image formation is repeated in the same manner.

The paper P having passed through the fixing section 7 is conveyed to the joint housing 20b through a perpendicular conveyance path 18, which extends perpendicularly upward. The perpendicular conveyance path 18 branches at its upper part to upper and lower two conveyance paths leftward in the joint housing 20b. A switching claw 17 arranged at the branch switches the paper conveyance direction for the paper P.

Inside the joint housing 20b, the paper ejection section is disposed which is composed of a first main body side ejection roller pair 19a and a second main body side ejection roller pair 19b (conveyance roller pairs). The second main body side ejection roller pair 19b is arranged above the first main body side ejection roller pair 19a. The switching claw 17 guides the paper P conveyed through the perpendicular conveyance path 18 to the upper conveyance path or the lower conveyance path. Further, a job separator 25 as a recording medium ejection device is arranged downstream of the second main body side ejection roller pair 19b. Description about the configuration of the job separator 25 will be made later in detail.

The paper P guided to the lower conveyance path by the switching claw 17 is ejected leftward from the first main body side ejection roller pair 19a and is stocked on a first exit tray 24 formed on the bottom of the inner ejection space 22. By contrast, the paper P guided to the upper conveyance path by the switching claw 17 passes through the job separator 25 from the second main body side ejection roller pair 19b and is ejected onto a second exit tray 31, which is detachably provided downstream of the job separator 25 in a direction in which paper is ejected (a paper ejection direction). The switching claw 17 is configured to switch a direction in which the paper is guided (a paper guiding direction) according to a control signal from the control section 80.

In the case where images are formed on both surfaces of the paper P, the switching claw 17 guides the paper having passed through the fixing section 7 to the upper conveyance path. Then, part of the paper P is once projected outside the image forming apparatus from the job separator 25. Thereafter, the second main body side ejection roller pair 19b is rotated in the reverse direction to switch the paper conveyance direction (switch back). Thus, the paper P is guided to a reversed paper conveyance path 23 rather than the perpendicular conveyance path 18 to be conveyed again through the reversed paper conveyance path 23 to the registration roller pair 9 with the image receiving surface reversed. Subsequently, the transfer device 14 transfers a next image formed on the photosensitive drum 10 to the surface of the paper on which no image is formed. After the paper P is conveyed to the fixing section 7, and the toner image is fixed to the paper P, the paper P is ejected onto the first exit tray 24 through the first main body side ejection roller pair 19a.

With the above configuration, in which the second main body side ejection roller pair 19a switches back the paper P of which both surfaces are to be subjected to image formation, succeeding paper P can be ejected onto the first exit tray 24 through the first main body side ejection roller pair 19a during switch back of preceding paper P. Accordingly, the succeeding paper P can be subjected to image formation and ejection before completion of switched back of the preceding paper P, of which both surfaces are already subjected to image formation, thereby increasing efficiency of image formation. Further, in order to change an ejection goal according to the types of job, or the like, the job separator 25 and the second exit tray 31 can be detached according to the condition of use by the user.

It is noted that the user may switch the paper guiding direction for the paper P through a touch panel (not shown). For example, it is possible that the paper P subjected to usual image formation is ejected onto the first exit tray 24, while paper P on which data received through a faxing function is printed is ejected onto the second exit tray 31.

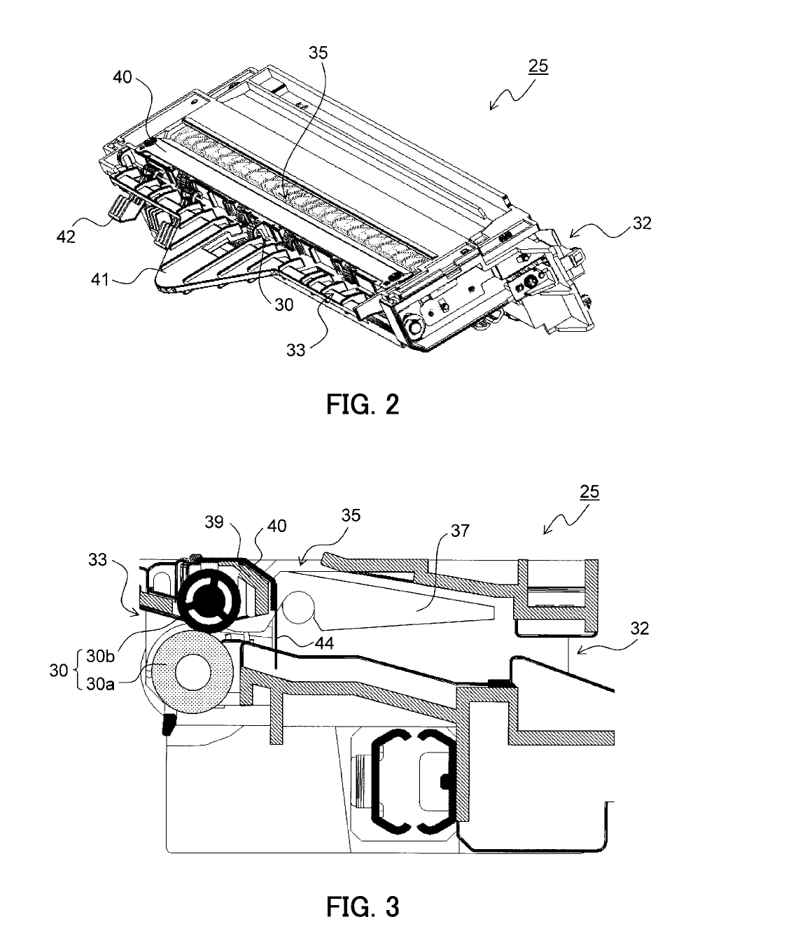

FIG. 2 is a perspective view showing outer appearance of the job separator 25 in FIG. 1. FIG. 3 is a side cross sectional view of the job separator 25. The job separator 25 includes a paper conveyance port 32 (hereinafter it may be referred to as a conveyance port 32 also), which communicates with the perpendicular conveyance path 18 in the joint housing 20b, a paper exit port 33 (hereinafter it may be referred to as an exit port 33 also), which opens toward the second exit tray 31, and a reversing port 35 for switch back of the paper in forming images on both surfaces of the paper. A branch guide 37, which is configured to switch the paper conveyance direction between toward the exit port 33 and toward the reversing port 35, is arranged upstream (right in FIG. 3) of the exit port 33 and the reversing port 35 in the paper conveyance direction.

At the exit port 33, a plurality of job separator side ejection roller pairs 30 (hereinafter referred to as ejection roller pairs 30 also) are arranged in the width direction of the paper. Each job separator side ejection roller pair 30 includes an ejection roller 30a (or an ejection roll 30a) and a driven roller 30b (or a driven roll 30b). In the present embodiment, the job separator 25 includes a resin frame 39. The driven roller 30b is supported by the resin frame 39 above the exit port 33 to be in press contact with the ejection roller 30a by predetermined pressing force. The driven roller 30b is located on the ejection roller 30a in the present embodiment. Alternatively, the driven roller 30b may be located below the ejection roller 30a.

The job separator 25 further includes a guide rib 41 arranged above the exit port 33 and a paper pressing member 42 arranged below the exit port 33. The guide rib 41 protrudes downstream in the paper ejection direction from the edge of the reversing port 35 to support the lower surface of the paper projected from the reversing port 35. The paper pressing member 42 presses the rear end part of the paper stocked on the second exit tray 31 (see FIG. 1).

Moreover, the resin frame 39 forms at least part of the inner peripheral surface of the reversing port 35. A reinforcing member 40 is provided over part of the surface of the resin frame 39, which corresponds to the entire inner wall surface of the reversing port 35, across a direction orthogonal to the paper conveyance direction (perpendicular direction of the paper of FIG. 3). The reinforcing member 40 is formed of a metal plate in a bent shape along the shape of the resin frame 39. A charge neutralizing brush 44, which is configured to remove static electricity on the paper ejected from the exit port 33 onto the second exit tray 31 (FIG. 1), is provided at the lower end of the reinforcing member 40.

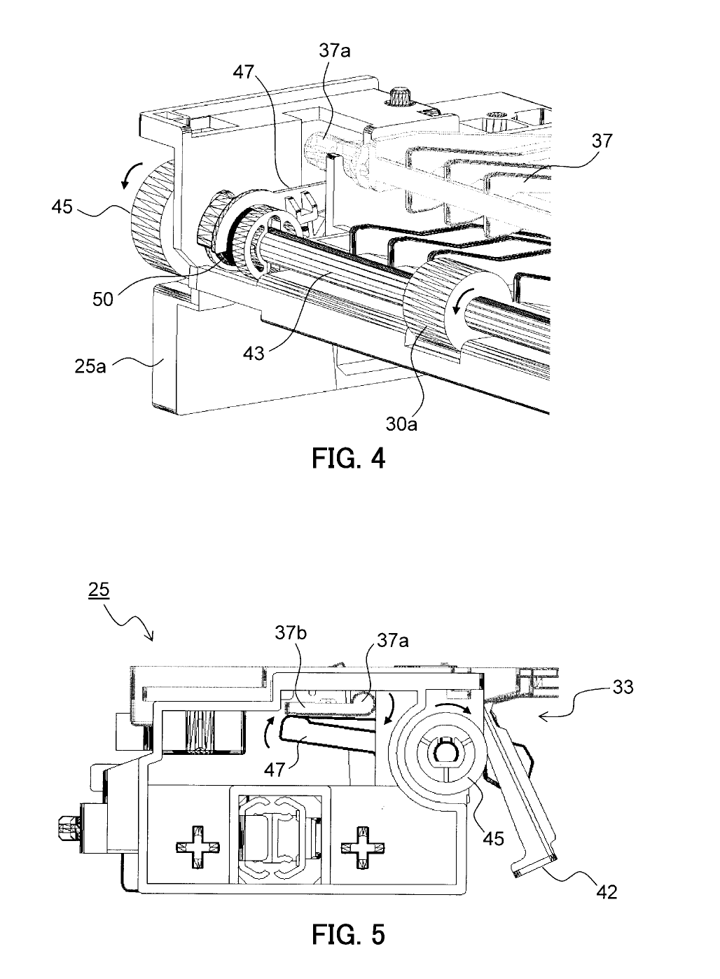

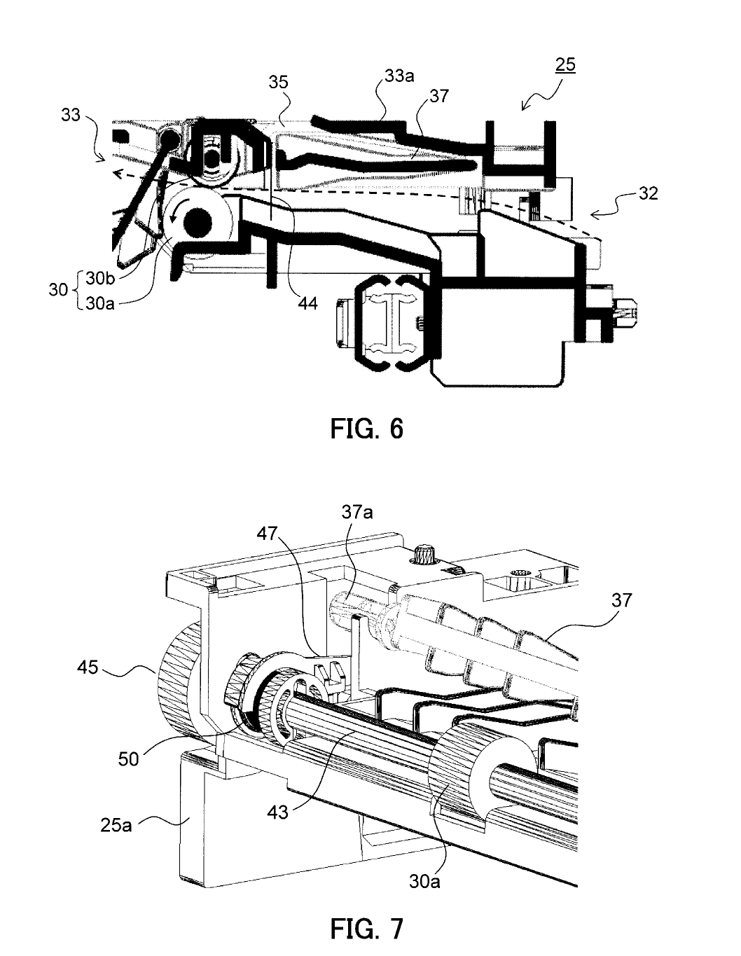

FIG. 4 is a partial perspective view showing the vicinity of a supporting point 37a of the branch guide 37 in ejecting the paper from the exit port 33 of the job separator 25. FIG. 5 is a side view when viewing the job separator 25 in the state shown in FIG. 4 as viewed from the rear side of the paper of FIG. 2. FIG. 6 is a side cross sectional view of the job separator 25 in the state shown in FIG. 4. It is noted that in FIG. 5, the paper ejection direction and the direction of rotation of the ejection roller 30a are opposite to those in FIGS. 4 and 6.

The job separator 25 includes an arm member 47. The arm member 47 is turnably supported at its one end to one end of a rotary shaft 43 for the ejection roller 30a. The other end of the arm member 47 is in contact with part of the branch guide 37. A torque limiter 50 is arranged at a joint part between the rotary shaft 43 and the arm member 47. The arm member 47 can freely turn about the rotary shaft 43 only when torque over a predetermined value is applied to the arm member 47. In other words, the arm member 47 is restrained from turning about the rotary shaft 43 for the ejection roller 30a when the rotation torque is not exceeding the predetermined value.

The branch guide 37 includes a support shaft 37a, a guide 37b, and a protrusion 37c. The support shaft 37a has a shape extending in the longitudinal direction (a direction perpendicular to the paper of FIG. 5). The support shaft 37a is rotatably supported at the opposite ends thereof in longitudinal direction to the side surfaces of a housing 25a of the job separator 25. The guide 37b extends upstream in the paper ejection direction from the support shaft 37a. The protrusion 37c extends upstream in the paper ejection direction from one of the ends in the longitudinal direction of the support shaft 37a. The protrusion 37c sways together with the guide 37b about the support shaft 37a as a supporting point (hereinafter it may be referred to as a supporting point also). As shown in FIG. 5, the sway end part of the protrusion 37c abuts on the upper surface of the free end of the arm member 47.

With reference to FIGS. 4-6 and FIGS. 1-3 on occasion, detailed description will be made next about a sequence of paper conveyance in ejecting the paper from the job separator 25 onto the second exit tray 31. The image forming section 6 performs image formation on one of the surfaces of the paper. Then, the fixing roller pair 7a fixes the image. Thereafter, the paper passes upward through the perpendicular conveyance path 18 and is conveyed from the paper conveyance port 32 to the job separator 25 through the second main body side ejection roller pair 19b.

Then, in order to eject the paper from the exit port 33 by rotating the ejection roller 30a in the anticlockwise direction in FIGS. 4 and 6 (the clockwise direction in FIG. 5), rotational drive force is transmitted from a drive input gear 45 to the ejection roller 30a through the rotary shaft 43. During the rotation, the own weight of the branch guide 37 as a rotational load acts on the torque limiter 50 through the arm member 47. However, the load by the own weight of the branch guide 37 is smaller than a torque necessary for rotation of the torque limiter 50. Therefore, the arm member 47 turns together with the rotary shaft 43 in the anticlockwise direction in FIG. 4 (the clockwise direction in FIG. 5).

The turn of the arm member 47 urges the sway end part of the branch guide 37. As shown in FIG. 5, the arm member 47 pushes up the protrusion 37c of the branch guide 37 to sway the branch guide 37 about the supporting point 37a as a center in the anticlockwise direction in FIGS. 4 and 6 (the clockwise direction in FIG. 5). As shown in FIG. 6, when the branch guide 37 sways up to be substantially horizontal, the branch guide 37 comes in contact with the upper inner surface of the housing 25a. Thereafter, since the rotational torque acting on the torque limiter 50 becomes larger than the torque necessary for rotation of the torque limiter 50, even after the branch guide 37 comes in contact with the upper inner surface of the housing 25a, the rotary shaft 43 and the ejection roller 30a continue to rotate and keep the branch guide 37 substantially horizontal.

Thus, the branch guide 37 moves to a position (hereinafter referred to as a first position) to guide the paper conveyed from the paper conveyance port 32 to the exit port 33. The tip end of the paper, which has passed through the second main body side ejection roller pair 19b, is guided to the ejection roller pair 30 along the lower surface of the branch guide 37, as indicated by a broken arrow in FIG. 6. Subsequently, the paper comes in contact with the charge neutralizing brush 44, thereby removing static electricity on the paper. Then, the ejection roller pair 30 ejects the paper onto the second exit tray 31.

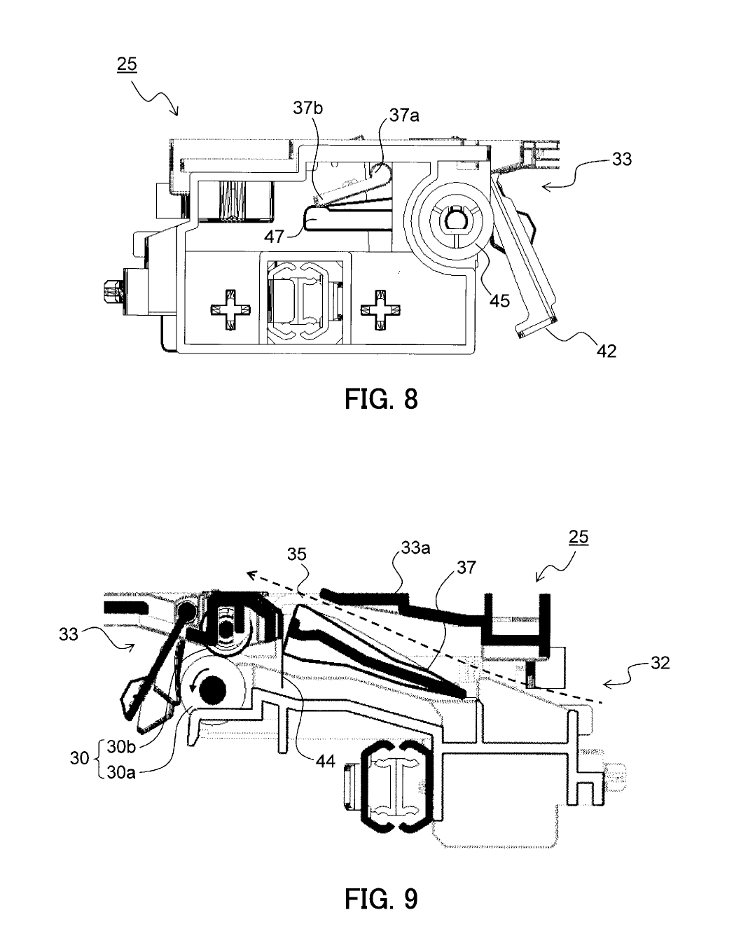

FIG. 7 is a partial perspective view showing the vicinity of the supporting point 37a of the branch guide 37 in paper switch back using the reversing port 35. FIG. 8 is a side view of the job separator 25 in the state shown in FIG. 7 as viewed from the rear side of the paper of FIG. 2. FIG. 9 is a side cross sectional view of the job separator 25 in the state shown in FIG. 7. It is noted that in FIG. 8, the paper ejection direction and the direction of rotation of the ejection roller 30a are opposite to those in FIGS. 7 and 9. With reference to FIGS. 7-9 and FIGS. 1-3 on occasion, detailed description will be made about a sequence of paper conveyance in projecting part of the paper from the reversing port 35 of the job separator 25 and switching back of the paper.

In paper switch back using the reversing port 35, no rotation of the ejection roller 30a is necessary. Accordingly, no rotational drive force from the drive input gear 45 is input to the rotary shaft 43. Further, the arm member 47 does not turn. Accordingly, the arm member 47 does not push up the protrusion 37c of the branch guide 37. By the weight of its own, the branch guide 37 is kept in the state in which the upstream part in the paper ejection direction of the branch guide 37 is inclined downward.

Thus, the branch guide 37 is located at a position (hereinafter referred to as a second position) to guide the paper conveyed from the paper conveyance port 32 to the reversing port 35. The tip end of the paper, which has been passed through the second main body side ejection roller pair 19b, is guided to the reversing port 35 along the upper surface of the branch guide 37, as indicated by the broken arrow in FIG. 9. Then, the second main body side ejection roller pair 19b allows part of the paper to be projected from the reversing port 35.

It is noted that the branch guide 37 may not necessarily move to the second point by only the weight of its own and may stop in the middle between the first point and the second point. For this reason, the ejection roller 30a may be rotated in the reverse direction for a moment (several ten msec) immediately before paper switch back to move the branch guide 37 to the second point. Alternatively, other than the own weight of the branch guide 37 and the rotation of the ejection roller 30a in the reverse rotation, the branch guide 37 may move to the second point by an urging member, such as a spring.

Subsequently, the second main body side ejection roller pair 19b is rotated in the reverse rotation, so that the paper is drawn from the reversing port 35 into the job separator 25 again and is guided to the reversed paper conveyance path 23 along the upper surface of the branch guide 37.

Thereafter, the paper having passed through the reversed paper conveyance path 23 is conveyed to the upstream of the registration roller pair 9 with its surface, on which the image has been formed, reversed (downward in FIG. 1). Then, the paper is conveyed between the photosensitive drum 10 and the transfer device 14 at predetermined timing. This can result in transfer of a new toner image formed on the photosensitive drum 10 to the surface of the paper on which no image is formed. The paper to which the toner images are transferred is ejected onto the first exit tray 24 via the fixing section 7 and the first main body side ejection roller pair 19a. Alternatively, the paper is conveyed into the job separator 25 via the second main body side ejection roller pair 19b, and is then guided to the ejection roller pair 30 along the lower surface of the branch guide 37 to be ejected onto the second exit tray 31.

With the above described configuration, the reversing port 35 is used for paper switch back in image formation on both surfaces. Accordingly, drawbacks caused in paper switch back using the ejection roller pair 30 can be reduced (e.g., the paper stocked on the second exit tray 31 is misaligned, or is caught by the ejection roller pair 30). Further, the part of the paper projected from the reversing port 35 is supported by the guide rib 41 to be prevented from being hung down. Accordingly, the paper subjected to switch back can be prevented from being folded. Further, the paper stocked on the second exit tray 31 is prevented effectively from being misaligned. In addition, the pressing member 42 presses the rear end part of the paper stoked on the second exit tray 31 (see FIG. 1), thereby achieving proper alignment and stackability of the paper.

Moreover, in association with rotation or rotation stop of the ejection roller pair 30, the branch guide 37 moves and switches between the first position and the second position. This can result in simplification of the swaying mechanism of the branch guide 37. Further, no additional mechanism (e.g., a solenoid or the like) for swaying the blanch guide 37 is needed.

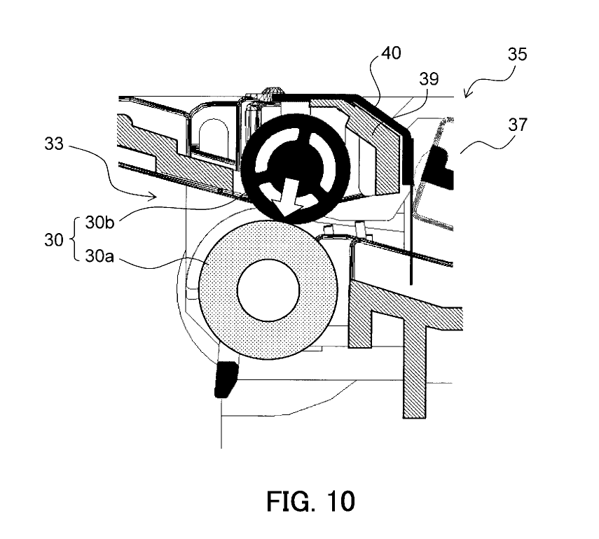

FIG. 10 is a partial enlarged view of the vicinity of the ejection roller pair 30 in FIG. 3. Provision of the reinforcing member 40 in the direction orthogonal to the paper ejection direction of the resin frame 39 can increase the rigidity of the resin frame 39. This can prevent thermal expansion of the resin frame 39 by heat radiated from the paper passing through the job separator 25. Thus, the reversing port 35 can be prevented from deformation caused by warp or bending of the resin frame 39. Furthermore, the driven roller 30b, which composes the ejection roller pair 30, is supported by the resin frame 39, so that the pressing force (indicated by the arrow in FIG. 10) by the driven roller 30b against the ejection roller 30a can be kept constant. Accordingly, variation in conveyance force can be reduced, which is caused by variation in pressure by the nip of the ejection roller pair 30.

In addition, the reinforcing member 40 is bent along the shape of the resin frame 39 forming the inner wall surface of the reversing port 35. This can allow the tip end of the paper to smoothly enter the reversing port 35 along the bent shape of the reinforcing member 40. That is, the reinforcing member 40 can function also as a conveyance guide to guide the paper to the reversing port 35. This can result in reduction in the number of components when compared with one in which the reinforcing member 40 is separated from a conveyance guide, thereby offering advantage in cost.

Moreover, the paper entering the reversing port 35 comes in contact with the metal reinforcing member 40 to remove static electricity on the paper. This can prevent drawbacks, such as a jam of electrostatically charged paper in the reversed paper conveyance path 23 and adhesion of foreign matter to the paper.

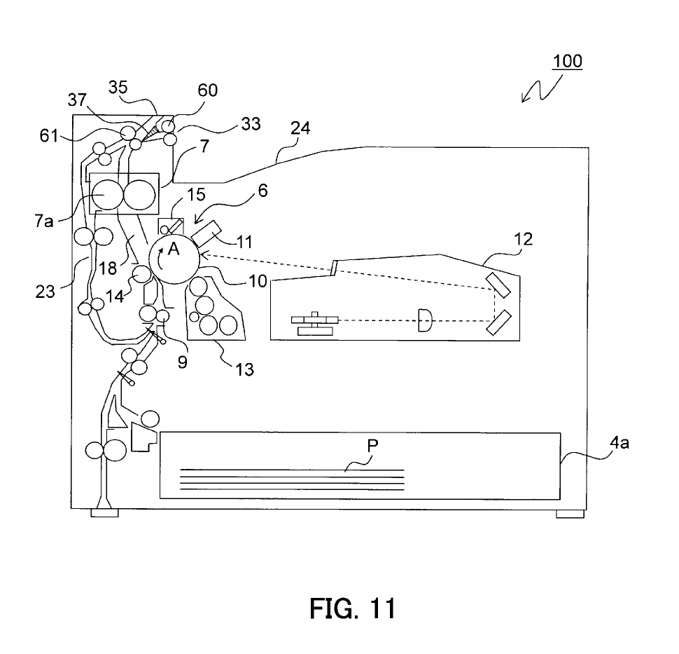

Besides, the present disclosure is not limited to the above embodiments, and various modifications are possible within the scope not deviated from the subject matter of the present disclosure. For example, the above embodiment describes the configurations of the image forming apparatus 100 of inner output type including the first main body side ejection roller pair 19a and the second main body side ejection roller pair 19b to which the job separator 25 of the present disclosure is connected. Alternatively, the present disclosure can be applicable to another image forming apparatus 100 as shown in FIG. 11, for example.

Referring to FIG. 11, the image forming apparatus 100 is a monochrome printer. The image forming apparatus 100 includes an exit port 33, at which an ejection roller pair 60 is provided. The reversing port 35 is arranged above the ejection roller pair 60. The branch guide 37, which is configured to switch the paper conveyance direction between toward the exit port 33 and toward the reversing port 35, is arranged upstream of the exit port 33 and the reversing port 35 in the paper conveyance direction. The swaying mechanism of the branch guide 37 is the same as that shown in FIGS. 4-9. Accordingly, the description thereof is omitted.

With the configuration shown in FIG. 11, paper switch back is performed using the reversing port 35 and a conveyance roller pair 61 located upstream of the ejection roller pair 60 with the rotation of the ejection roller pair 60 stopped. This can prevent drawbacks, such as misalignment of the paper stocked on the first exit tray 24 and a catch of the paper by the ejection roller pair 60, likewise the case shown in FIGS. 1-10. In addition, in association with the rotation or rotation stop of the ejection roller pair 60, the branch guide 37 moves and switches between the first position and the second position. Thus, the swaying mechanism of the branch guide 37 can be simplified.

It is noted that the present disclosure is, of course, applicable not only to monochrome multifunction peripherals as shown in FIG. 1 and monochrome printers as shown in FIG. 11, but also to any other image forming apparatuses, such as analog copiers, color copiers, monochrome printers, color printers, facsimile machines, etc.

The present disclosure is applicable to recording medium ejection devices in which a recording medium is ejected onto an exit tray and is reversed for image formation of both surfaces of the recording medium. According to the present disclosure, drawbacks can be prevented, such as misalignment of recording mediums stocked on the exit tray and a catch of a stocked recording medium together with a recording medium subjected to switch back by the ejection roller pair when the recording medium subjected to switch back is drawn into the image forming apparatus.

What is claimed is:

1. A recording medium ejection device, comprising:
an exit port from which a recording medium is ejected;
an ejection roller pair arranged at the exit port;
a reversing port formed above the exit port; and
a branch guide provided in a conveyance path through which the recording medium is conveyed to the exit port,
wherein the branch guide is configured to move between a first position to guide the recording medium to the exit port and a second position to guide the recording medium to the reversing port,
with the branch guide located at the first position, the ejection roller pair is rotated to eject the recording medium from the exit port, and
with the branch guide located at the second position, a conveyance roller pair, which is located upstream of the ejection roller pair in a recording medium ejection direction, is rotated to allow part of the recording medium to be projected from the reversing port and is rotated in a reverse direction to switch back the recording medium.

2. The device of claim 1, wherein
the branch guide is located at the second position when the ejection roller pair is stopped, and moves to the first position by rotation of the ejection roller pair.

3. The device of claim 2, further comprising:
an arm member with one end turnably supported to a rotary shaft for one of ejection rollers composing the ejection roller pair and the other end being in contact with part of the branch guide,
wherein a torque limiter, which is configured to restrain the arm member from turning about the rotary shaft when a rotation torque is not exceeding a predetermined value, is provided at a joint part between the arm member and the rotary shaft,
the branch guide is supported at its supporting point located on the downstream side in the recording medium ejection direction so as to be swayable between the first position and the second position,
the branch guide is located at the second position by its own weight when the ejection roller pair is stopped,
when the ejection roller pair is rotated, the arm member urges a sway end part of the branch guide, and
the branch guide moves to the first position by urging by the arm member.

4. The device of claim 1, further comprising:
a resin frame which forms part of the reversing port,
wherein a metal reinforcing member, which extends in a direction orthogonal to a direction in which the recording medium is conveyed, is provided on the resin frame.

5. The device of claim 4, wherein
the resin frame supports one of ejection rollers composing the ejection roller pair.

6. The device of claim 4, wherein
the resin frame forms at least part of an inner wall of the reversing port, and the reinforcing member is arranged along the inner wall surface of the reversing port.

7. The device of claim 1, further comprising:
a guide rib protruding downstream in the recording medium ejection direction from an edge of the reversing port.

8. The device of claim 1, further comprising:
a paper pressing member arranged below the exit port.

9. An image forming apparatus, comprising:
the recording medium ejection device of claim 1; and
an image forming section arranged upstream of the recording medium ejection device in the recording medium ejection direction and configured to form an image on the recording medium.

10. An image forming apparatus in which an inner ejection space is formed so as to open at least at the front of the image forming apparatus, comprising:
a recording medium ejection device;
an image forming section arranged upstream of the recording medium ejection device in a recording medium ejection direction and configured to form an image on a recording medium;
a first exit tray formed on the bottom of the inner ejection space;
a first main body side ejection roller pair configured to eject the recording medium onto the first exit tray;
a second main body side ejection roller pair arranged above the first main body side ejection roller pair upstream of the recording medium ejection device; and
a second exit tray detachably provided downstream of the recording medium ejection device,
wherein the recording medium ejection device includes:
an exit port from which a recording medium is ejected;
an ejection roller pair arranged at the exit port;
a reversing port formed above the exit port; and
a branch guide provided in a conveyance path through which the recording medium is conveyed to the exit port,
the branch guide is configured to move between a first position to guide the recording medium to the exit port and a second position to guide the recording medium to the reversing port,
with the branch guide located at the first position, the ejection roller pair is rotated to eject the recording medium from the exit port, and
with the branch guide located at the second position, the second main body side ejection roller pair, which is located upstream of the ejection roller pair in the recording medium ejection direction, is rotated to allow part of the recording medium to be projected from the reversing port and is rotated in a reverse direction to switch back the recording medium.
